(19) United States
(12) Patent Application Publication
(10) Pub. No.: US 2024/0269650 A1
(43) Pub. Date: Aug. 15, 2024

(54) SORBENT STORAGE OF HYDROCARBON GAS

(71) Applicant: CALGON CARBON CORPORATION, Moon Township, PA (US)

(72) Inventors: Michael GREENBANK, Moon Township, PA (US); Walter G. TRAMPOSCH, Moon Township, PA (US)

(73) Assignee: CALGON CARBON CORPORATION, Moon Township, PA (US)

(21) Appl. No.: 18/566,800

(22) PCT Filed: Jun. 6, 2022
(86) PCT No.: PCT/US2022/072779

§ 371 Date: Dec. 4, 2023

Related U.S. Application Data
(60) Provisional application No. 63/196,987, filed on Jun. 4, 2021.

(51) Int. Cl. B01J 20/28; B01J 20/20; C10L 3/06

(52) U.S. Cl. CPC B01J 20/28052; B01J 20/20; B01J 20/28011; B01J 20/2803; B01J 20/28035; B01J 20/2804; C10L 3/06

(57) ABSTRACT

Sorbent sheets containing sorbent and binder may be used for efficient adsorption and desorption of low-density hydrocarbons to the sorbent, such as activated carbon, therein. One or more sheets, optionally arranged in a multi-layered configuration, may be included in a housing for improved storage and transportation of low-density hydrocarbons such as natural gas.

This application claims priority to U.S. Provisional Application No. 63/196,987, filed Jun. 4, 2021, which is hereby incorporated by reference in its entirety.

### FIELD

The present disclosure relates generally to methods and systems for storing hydrocarbon gases.

### BACKGROUND

Low-density hydrocarbons such as natural gas have seen expanding use in recent years, not only for stationary use in heating and in industry, but also in the transportation sector. These low-density hydrocarbons are difficult to store and transport because they have low volumetric energy densities at standard temperature and pressure when compared to liquid hydrocarbons.

One common method used to store low-density hydrocarbons is through liquefaction of the hydrocarbons. For example, natural gas can be liquefied by cooling to about −162° C. at atmospheric pressure and is referred to as liquefied natural gas (LNG). The cooled LNG may then be transported via a vehicle (for example by rail, boat, or truck). The energy required to maintain LNG in its liquid form, however, is expensive. In an alternative method, low-density hydrocarbons may be pressurized within a storage container, thereby increasing the volumetric energy density, and thus overall energy storage capacity for a given container. However, use of high pressures requires reinforced tanks that are heavy, bulky, expensive, and still do not meet volumetric energy densities achieved in LNG storage applications. Therefore, there have been considerable efforts to find alternative methods for low-density hydrocarbon storage.

One such alternative method increases volumetric energy density by adsorbing low-density hydrocarbons onto a sorbent. Activated carbon-filled cylinders have been used for natural gas storage for decades, allowing for the same molar amount of natural gas to be stored at lower pressures versus an ordinary ‘empty’ cylinder. The natural gas adsorbed in the micropores and mesopores of the activated carbon achieves energy densities comparable to LNG. However, because activated carbon generally comes in granular, pellet, monolithic, or powder forms, filling a cylinder with these forms results in roughly 40% to 45% void volume between the particles. These voids store pressurized gas with the same efficiency as a conventional “empty” cylinder that contains no activated carbon, thus lowering the energy storage achievable by the cylinder on the whole. Attempts to reduce void volume have included the use of disk-shaped ceramic monoliths containing sorbents such as activated carbon in various forms. However, manufacturing such ceramic monoliths is expensive, time-consuming, and the kinds of sorbents that may be used in monolith structures are limited by the manufacturing processes of the ceramic binders.

There is a need for simple and convenient methods and systems that increase the volumetric energy storage density for stored low-density hydrocarbon fuels such as natural gas. Such methods and systems would represent an improvement in current technology, making storage and transport of low-density hydrocarbon fuels such as natural gas cheaper and easier.

### SUMMARY

In some aspects, the techniques described herein relate to a low-density hydrocarbon storage device including: a housing for storing a low-density hydrocarbon: wherein the housing contains a multi-layered sorbent sheet product having a void volume of about 20% (v/v) or less, wherein the multi-layered sorbent sheet product is partially or totally encapsulated within the housing.

In some aspects, the techniques described herein relate to a low-density hydrocarbon storage device, wherein the multi-layered sorbent sheet product is at least one of: a stacked sorbent sheet product including a plurality of sorbent sheets, each sorbent sheet within the stacked sorbent sheet product including at least one sorbent material and at least one binder, wherein the plurality of sorbent sheets is arranged such that each sorbent sheet is substantially congruent with the sorbent sheet adjacent thereto thereby forming stacked sorbent sheets and having a void volume of about 10% or less, and a rolled sorbent sheet product including at least one sorbent sheet configured into a tubular profile positioned about a central axis and having a void volume of about 20% or less, wherein the sorbent sheet includes at least one sorbent material and at least one binder.

In some aspects, the techniques described herein relate to a low-density hydrocarbon storage device, further including a heat transfer mechanism.

In some aspects, the techniques described herein relate to a low-density hydrocarbon storage device, having a volumetric energy storage density for low-density hydrocarbons that is at least 10% greater than a storage device including a volume of activated carbon identical to the volume of the multi-layered sorbent sheet product.

In some aspects, the techniques described herein relate to a low-density hydrocarbon storage device, wherein the housing is cylindrical.

In some aspects, the techniques described herein relate to a low-density hydrocarbon storage device, wherein the housing is irregularly shaped.

In some aspects, the techniques described herein relate to a low-density hydrocarbon storage device, wherein each sorbent sheet includes about 85 wt. % to about 95 wt. % of the sorbent material.

In some aspects, the techniques described herein relate to a low-density hydrocarbon storage device, wherein each sorbent sheet includes about 90 wt. % of the sorbent material.

In some aspects, the techniques described herein relate to a low-density hydrocarbon storage device, wherein the sorbent material includes one or more of activated carbon, reactivated carbon, natural or synthetic zeolite, silica, nanotubes, and graphene.

In some aspects, the techniques described herein relate to a low-density hydrocarbon storage device, wherein the binder includes one or more of a polytetrafluoroethylene (PTFE), polyvinylidene fluoride, ethylene-propylene-diene rubber, polyethylene oxide, UV-curable acrylate, UV-curable methacry late, heat-curable divinyl ether, polybutylene terephthalate (PBT), acetal or polyoxymethylene resin, fluoroelastomer, perfluoroelastomer (FFKM) and/or tetrafluoro ethylene/propylene rubber (FEPM), aramid polymer, para-aramid polymer, meta-aramid polymer, poly trimethylene terephthalate (PTT), ethylene acrylic elastomer, polyimide, polyamide-imide, polyurethane, low-density polyethylene, high density polyethylene, polypropylene, biaxially-oriented polypropylene (BoPP), polyethylene terephthalate (PET), biaxially-oriented polyethylene terephthalate (BoPET), polychloroprene, and any copolymer of any thereof.

In some aspects, the techniques described herein relate to a low-density hydrocarbon storage device, wherein the binder includes PTFE.

In some aspects, the techniques described herein relate to a low-density hydrocarbon storage device, wherein the sorbent material includes activated carbon.

In some aspects, the techniques described herein relate to a low-density hydrocarbon storage device, wherein each of the plurality of sheets has a thickness of about 0.10 mm to about 10 mm.

In some aspects, the techniques described herein relate to a low-density hydrocarbon storage device, wherein the stacked sorbent sheet product has a density of about 80 kg/m3 to about 1500 kg/m3.

In some aspects, the techniques described herein relate to a low-density hydrocarbon storage device, wherein the stacked sorbent sheets have been subjected to compression.

In some aspects, the techniques described herein relate to a low-density hydrocarbon storage device, wherein the stacked sorbent sheets form a cylindrical shape.

In some aspects, the techniques described herein relate to a low-density hydrocarbon storage device, wherein the multi-layered sorbent sheet product includes at least one sorbent sheet configured into a tubular profile positioned about a central axis and having a void volume of about 20% or less, wherein the sorbent sheet includes at least one sorbent material and at least one binder.

In some aspects, the techniques described herein relate to a low-density hydrocarbon storage device, wherein the at least one sorbent sheet is spirally wound around the central axis.

In some aspects, the techniques described herein relate to a low-density hydrocarbon storage device, including at least two sorbent sheets arranged to form at least two concentric rings in cross-section of a similarly-sized tubular structures.

In some aspects, the techniques described herein relate to a low-density hydrocarbon storage device, wherein the rolled sorbent sheet product has a density of about 80 kg/m3 to about 1500 kg/m3.

In some aspects, the techniques described herein relate to a low-density hydrocarbon storage device, wherein the rolled sorbent sheet product has been subjected to compression.

In some aspects, the techniques described herein relate to a method for selectively storing or delivering low-density hydrocarbons, including steps of: providing low-density hydrocarbon storage device which includes a housing for storing a low-density hydrocarbon: wherein the housing contains a multi-layered sorbent sheet product having a void volume of about 20% (v/v) or less, wherein the multi-layered sorbent sheet product is partially or totally encapsulated within the housing: selectively filling or emptying the low-density hydrocarbon storage device, wherein filling the low-density hydrocarbon storage device includes adsorbing one or more low-density hydrocarbons onto the multi-layered sorbent sheet product for storing the low-density hydrocarbon in the storage device, and emptying the low-density hydrocarbon storage device includes desorbing one or more low-density hydrocarbons from the multi-layered sorbent sheet product for delivering the low-density hydrocarbon from the storage device.

In some aspects, the techniques described herein relate to a method, wherein the multi-layered sorbent sheet product is selected from one or more of a stacked sorbent sheet product including a plurality of sorbent sheets, each sorbent sheet within the stacked sorbent sheet product including at least one sorbent material and at least one binder, wherein the plurality of sorbent sheets is arranged such that each sorbent sheet is substantially congruent with the sorbent sheet adjacent thereto thereby forming stacked sorbent sheets and having a void volume of about 10% or less, and a rolled sorbent sheet product including at least one sorbent sheet configured into a tubular profile positioned about a central axis and having a void volume of about 20% or less.

In some aspects, the techniques described herein relate to a method, wherein the low-density hydrocarbon is natural gas.

Provided herein is a stacked sorbent sheet product comprising a plurality of sorbent sheets, each sorbent sheet within the plurality comprising at least one sorbent material and at least one binder, wherein the plurality of sorbent sheets is arranged such that each sorbent sheet is substantially congruent with the sorbent sheet adjacent thereto thereby forming stacked sorbent sheets. Each sorbent sheet may comprise about 85 wt. % to about 95 wt. % of the sorbent material, for example, about 90 wt. % of the sorbent material. The sorbent material may comprise one or more of activated carbon, reactivated carbon, natural and synthetic zeolite, nanotubes, graphene, or silica, preferably activated carbon.

Suitable binders include, but are not limited to, one or more of polytetrafluoroethylene (PTFE), polyvinylidene fluorides (e.g., PVD₂, PVDF), ethylene-propylene-diene rubbers (EPDM rubbers), polyethylene oxide (PEO), UV-curable acrylate, UV-curable methacrylate, heat-curable divinyl ether, poly butylene terephthalate (PBT), acetal or polyoxymethylene resin, fluoroelastomer, perfluoroelastomer (FFKM) and/or tetrafluoro ethylene/propylene rubber (FEPM), aramid polymer, para-aramid polymer, meta-aramid polymer, poly trimethylene terephthalate (PTT), ethylene acrylic elastomer, polyimide, polyamide-imide, polyurethane (PU), low-density polyethylene (LDPE), high density polyethylene (HDPE), polypropylene (PP), biaxially-oriented polypropylene (BoPP), polyethylene terephthalate (PET), biaxially-oriented polyethylene terephthalate (BoPET), polychloroprene (CR), and any copolymer of any thereof. In one or more embodiments, the binder comprises PTFE.

Stacked sorbent sheet products may comprise one or more sorbent sheets, each having a thickness of about 0.10 mm to about 10 mm, such as about 0.10 mm to about 5 mm, or about 0.5 mm to about 2 mm. A stacked sorbent sheet product may have a density of about 80 kg/m3 to about 1500 kg/m3. Optionally, the stacked sorbent sheets or sheet product has been subjected to compression. Stacked sorbent sheets may form any three-dimensional shape, for example, a cylindrical shape.

Additionally, provided herein is a rolled sorbent sheet product comprising at least one sorbent sheet configured into a tubular profile positioned about a central axis, wherein the sorbent sheet comprises at least one sorbent material and at least one binder. For example, in one configuration, at least one sorbent sheet is spirally wound around the central axis. In another configuration, the rolled sorbent sheet product comprises at least two sorbent sheets arranged to form at least two concentric rings in cross-section of a similarly sized tubular structures. As with the stacked sorbent sheet product, the one or more sorbent sheets in a rolled sorbent sheet product may comprise about 85 wt. % to about 95 wt. % of sorbent material, for example, about 90 wt. % of sorbent material. The sorbent material may comprise one or more of activated carbon, reactivated carbon, natural and synthetic zeolite, nanotubes, graphene, carbonaceous char, and silica.

Rolled sorbent sheet products may comprise one or more sorbent sheets, each having a thickness of about 0.10 mm to about 10.0 mm. A rolled sorbent sheet product may have a density of about 80 kg/m³ to about 1500 kg/m³. Optionally, the rolled sorbent sheet/s or sheet product has been subjected to compression.

Additionally, provided herein is a low-density hydrocarbon storage device comprising a housing and one or more of the aforementioned stacked sorbent sheet products and rolled sorbent sheet products partially or totally encapsulated therein. A low-density hydrocarbon storage device configured in this manner may thus be characterized by a void volume of about 10% (v/v) or less, thereby having a storage capacity for low-density hydrocarbons that is at least 10% greater than a storage device comprising a volume of activated carbon identical to the low-density hydrocarbon storage device. Optionally, a low-density hydrocarbon storage device may comprise a heat transfer mechanism.

The housing of a low-density hydrocarbon storage device may be any shape, for example, cylindrical or irregular.

This summary is not intended to limit the scope of the claims. Other embodiments and aspects of the apparatus and methods disclosed herein will be apparent upon reading the full specification, without deviating from the scope and spirit of the disclosure.

### DRAWINGS

Aspects, features, benefits, and advantages of the embodiments described herein will be apparent with regard to the following description, appended claims, and accompanying drawings where:

FIG. 1 depicts one embodiment of a stacked sorbent sheet product.

FIG. 2 depicts one embodiment of a sorbent sheet product comprising one or more sorbent sheets spirally wound around a central axis thereby creating a rolled sorbent sheet product.

FIG. 3 depicts one embodiment of a sorbent sheet product comprising several sheets, each formed into a hollow cylinder, where a plurality of such sheets are sized and arranged to form concentric rings in cross-section of a similarly sized cylinder.

### DETAILED DESCRIPTION

Before the present compositions and methods are described, it is to be understood that the scope of the invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference with respect to the aspect it is identified as describing. Nothing herein is to be construed as an admission that the invention is not entitled to antedate such disclosure by virtue of prior invention.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%.

As used herein, the term “sorbent material” means any material that exhibits adsorbent properties, absorbent properties, or a combination of adsorbent properties and absorbent properties. Adsorbent properties mean that atoms, ions, or molecules adhere to the surface of the material. Absorbent properties means that atoms, ions, or molecule enter and are retained by a bulk phase of the material. By way of example, sorbent materials include but are not limited to activated carbon, reactivated carbon, natural and synthetic zeolite, silica, silica gel, alumina, zirconia, and diatomaceous earths. As used herein, “sorbent material” is a material whose constituent components are substantially adsorbent and/or absorbent, with only minimal components that are not adsorbent and/or absorbent (for example, the minimal amount of binder that is required for activated carbon pellets to maintain their shape).

As used herein, the term “sorbent” means any composition or composite that includes a sorbent material in a blend, mixture, composite, or compound with one or more additional materials that do not exhibit adsorbent properties. By way of example, one embodiment of sorbent includes an activated carbon sorbent material mixed with a thermally conductive filler.

As used herein, “low-density hydrocarbon” means a hydrocarbon or mixture of hydrocarbons that is a gas at standard temperature and pressure, which is 0° C. and an absolute pressure of 100 kPa (1 bar).

As used herein, “natural gas” means a low-density hydrocarbon that includes methane and other alkanes such as ethane and optionally a small amount of carbon dioxide, nitrogen, hydrogen sulfide, and helium. The source of natural gas is not limited and includes underground mineral deposits, synthetic processes, and biological processes.

Various embodiments of the invention, as described herein, are directed to devices containing one or more sheets comprising sorbent material, described herein as “sorbent sheets”, and methods for making sorbent sheet products and storage devices containing these sheets. Provided herein is a sorbent sheet, which may be composed of a sorbent material, a binder and have a thickness of less than about 10 mm, such as less than about 5 mm, less than 2 mm or less than 1 mm. Devices of various embodiments may include a housing and one or more sorbent sheets. Storage devices as described herein may advantageously achieve a void volume of about 10% or less of the total volume of the housing. As used herein, void volume refers to volume of the space between particles and excludes the volume of the pores in the activated carbon as well as any pores within the sorbent sheet itself.

For the design of any storage vessel or any adsorption column for low-density hydrocarbon (such as natural gas, methane, or ethane) adsorption, adsorption characteristics of these gases on activated carbon such as heat of adsorption, are an important design parameter. There is an ongoing need for the development of systems capable of adsorbing and desorbing these hydrocarbons more rapidly, thereby reducing the amount of time required to fill a tank and/or empty a tank. The process of adsorbing natural gas, ethane or methane is an exothermic process, releasing heat when the molecule of gas interacts with the wall of the pore which it has entered. Thus, as gas is adsorbed to the sorbent, the ambient temperature within the storage tank increases, diminishing the rate of methane uptake by the sorbent. Similarly, desorption of gas reduces the ambient pressure and temperature within the tank, concomitantly increasing the time necessary to deliver adsorbed gas from the tank. More efficient supply of energy to and dissipation of energy from the sorbent within a storage device would facilitate desorption and adsorption, respectively. In addition to improving overall storage capacity, the reduction of voids within a sorbent storage system would also improve efficiency of this energy transfer.

Disclosed herein is a low-density hydrocarbon storage device comprising a housing for storing a low-density hydrocarbon: wherein the housing contains a multi-layered sorbent sheet product having a void volume of about 20% (v/v) or less, wherein the multi-layered sorbent sheet product is partially or totally encapsulated within the housing.

The multi-layered sorbent sheet product may take the form of at least one of a stacked sorbent sheet product comprising a plurality of sorbent sheets, each sorbent sheet within the stacked sorbent sheet product comprising at least one sorbent material and at least one binder, wherein the plurality of sorbent sheets is arranged such that each sorbent sheet is substantially congruent with the sorbent sheet adjacent thereto thereby forming stacked sorbent sheets and having a void volume of about 10% or less, and a rolled sorbent sheet product comprising at least one sorbent sheet configured into a tubular profile positioned about a central axis and having a void volume of about 20% or less, wherein the sorbent sheet comprises at least one sorbent material and at least one binder.

Such a storage device is useful in a method for storing and delivering low-density hydrocarbons. Also disclosed herein is a method for selectively storing or delivering low-density hydrocarbons, comprising steps of providing low-density hydrocarbon storage device which comprises a housing for storing a low-density hydrocarbon: wherein the housing contains a multi-layered sorbent sheet product having a void volume of about 20% (v/v) or less, wherein the multi-layered sorbent sheet product is partially or totally encapsulated within the housing: selectively filling or emptying the low-density hydrocarbon storage device: wherein filling the low-density hydrocarbon storage device comprises adsorbing one or more low-density hydrocarbons onto the multi-layered sorbent sheet product for storing the low-density hydrocarbon in the storage device, and emptying the low-density hydrocarbon storage device comprises desorbing one or more low-density hydrocarbons from the multi-layered sorbent sheet product for delivering the low-density hydrocarbon from the storage device.

Additional details on the low-density hydrocarbon storage device, its component parts, and methods are provided below.

As such, provided herein is a sorbent sheet comprising at least one sorbent and at least one binder. A sorbent sheet, once produced, may then be manipulated in various ways for incorporation into a housing to yield a device useful for adsorbed low-density hydrocarbon applications. In particular, such a device may be useful in the storage of low-density hydrocarbons for future use or for transportation. The sorbent material may comprise one or more of activated carbon, reactivated carbon, natural and synthetic zeolite, nanotubes, graphene, carbonaceous char, and silica, activated carbon. For example, sorbent sheets comprising activated carbon may be incorporated into sorbent sheets that are incorporated into a storage device for storing natural gas.

Activated carbon may be derived from various sources known in the art including, but not limited to, bagasse, bamboo, coconut husks, peat, wood such as hardwood and softwood sources in the form of sawdust and scrap, lignite, coal and coal tar, petroleum pitch, asphalt and bitumen, corn stalks and husks, wheat straw, spent grains, rice hulls and husks, nutshells (such as coconut), and combinations thereof.

Suitable activated carbon may be provided in various grades and types selected based on performance requirements, cost, and other considerations. Activated carbon may be provided in powdered form or in granular form, such as (but not limited to) re-agglomerated carbon powder, crushed granules generated from processing (e.g., crushing, pulverizing, or the like) materials such as nutshells, wood, or coal, or pellets created by extrusion of carbonaceous materials. Activated carbon may be formed by processes of carbonization and activation or by direct activation. For example, raw material such as wood, nutshell, coal, pitch, or the like, may be oxidized and devolatilized with steam and/or carbon dioxide, and gasified to form pore structures in a carbonaceous material, thereby creating adsorption sites. Oxidation and devolatilization processes may include, for example, a chemical treatment with a dehydrating chemical, such as phosphoric acid, boric acid, sulfuric acid, sodium hydroxide, potassium hydroxide, and any combinations thereof.

A variety of activation processes are known in the art. Useful processes for providing activated carbon for a sorbent sheet as described herein may include acid treating a carbonaceous material such as wood or wood byproduct, for example, with phosphoric acid, and carbonizing the wood and/or wood byproducts using steam and/or carbon dioxide gasification. Carbon may also be activated by potassium hydroxide (KOH) or sodium hydroxide (NaOH) at high temperatures. Carbon may be activated to any desired apparent density, for example, to about 0.5 g/cm³ to about 3 g/cm³, such as about 0.5 g/cm³ to about 2 g/cm³, about 0.5 g/cm³ to about 1.5 g/cm³, about 0.5 g/cm³ to about 1.0 g/cm³, or any apparent density between any two such values, such as about 0.55 g/cm³, about 0.75 g/cm³, about 1.0 g/cm³, about 1.25 g/cm³, about 1.5 g/cm³, about 1.75 g/cm³, about 2.0 g/cm³, about 2.25 g/cm³, about 2.5 g/cm³, or about 2.75 g/cm³, or any range between any two of these values.

Optionally, a second sorbent may optionally be included in a sorbent sheet. Useful second sorbents include, but are not limited to, natural and synthetic zeolite, nanotubes, graphene, carbonaceous char, and silica, and any combination thereof.

A sorbent sheet may comprise about 75 wt. % to about 95 wt. % of one or more sorbents materials based on the weight of the mixture used to manufacture the sorbent sheet. For example, a sorbent sheet may comprise about 75 wt. % to about 88 wt. %, about 80 wt. % to about 90 wt. %, or about 85 wt. % to about 90 wt. % of a sorbent material (for example, activated carbon).

A sorbent sheet may further comprise at least one binder, preferably a polymeric binder. Suitable polymeric binders may include, but are not limited to, PTFE or TEFLON, polyvinylidene fluorides (e.g., PVF₂ or PVDF), EPDM rubbers, PEOs, UV-curable acrylates, UV-curable methacrylates, heat-curable divinyl ethers, PBT, acetal or polyoxymethylene resin, fluoroelastomers such as FFKM and FEPM, aramid polymers such as para-aramid and meta-aramid polymers, PTT, ethylene acrylic elastomers, polyimide, polyamide-imides, PU, LDPE, HDPE, PP, BoPP, PET, BoPET, CR, copolymers thereof, and any combination thereof. Suitable binders can be thermoplastic or thermosetting as conditions require, and can include mixtures of thermoplastic and thermosetting compounds. In particularly useful embodiments, a sorbent sheet comprises PTFE as a binder. Useful binder materials may be provided in pellet form, powder form, in a dispersion, or the like.

A sorbent sheet may comprise about 2 wt. % to about 20 wt. % of a binder based on the total weight of the sorbent sheet. Other contemplated binder concentrations include about 2 wt. % to about 18 wt. % or about 5 wt. % to about 15 wt. %, or any individual amount or range encompassing these example amounts, such as about 6 wt. %, about 7 wt. %, about 8 wt. %, about 9 wt. %, about 10 wt. %, about 11 wt. %, about 12 wt. %, about 13 wt. %, or about 14 wt. %.

Optionally, a sorbent sheet may comprise solvent (e.g., water), which may be residual from manufacturing processes. Such a residual solvent may be present in small amounts of, for example, less than 5% or less than 2% and greater than about 0.1% or 0.2% by weight. In any embodiment, a sorbent sheet may have no (0%) solvent.

Provided herein are methods for manufacturing sorbent sheets as described herein. For example, a sorbent sheet may be manufactured providing at least one sorbent material and at least one binder, mixing the sorbent material and the binder to form a premixture, and processing the premixture with heat to produce a sorbent sheet comprising the sorbent material and the binder. The sorbent material and binder may be any material as described above.

The at least one sorbent material provided may exhibit an average particle diameter of about 1 μm to about 100 μm, about 1 μm to about 50 μm, about 1 μm to about 42 μm, about 5 μm to about 35 μm, about 10 μm to about 30 μm, or any individual particle diameter or range encompassed by these example ranges. The particle size (average or distribution) of the sorbent material may be chosen, for example, to increase packing efficiency of a sorbent together with a binder within a sorbent sheet. The above described particle sizes may be achieved, if not readily available, for example, by size reduction processing (e.g., grinding, pulverizing) activated carbon to a powder.

The at least one binder provided may exhibit an average particle size about 0.10 times to about 10 times the average particle size of the sorbent material with which it will be combined to form a sorbent sheet. For example, a binder may have an average particle size of about one-third of the size of the sorbent material particle size or a particle size about equal to the sorbent material particle size. The at least one binder may be provided, for example, as a powder or as a dispersion in liquid (e.g., a slurry). Sorbent material/s and binder/s may be combined to form a premixture comprising about 5 wt. % to about 25 wt. % of the at least one binder based on the total weight of the premixture. Other binder concentrations include about 12 wt. % to about 25 wt. %, about 10 wt. % to about 15 wt. %, and any individual amount or range encompassed therein. A premixture may comprise about 75 wt. % to about 90 wt. % of the one or more sorbent materials based on the total weight of the premixture. Other sorbent material concentrations include about 75 wt. % to about 88 wt. %, about 80 wt. % to about 90 wt. %, about 85 wt. % to about 90 wt. %, and any range or individual concentration encompassed therein.

A premixture comprising sorbent material/s and binder/s may be heated and blended, followed by roll milling to form a sorbent sheet. Heating can be applied during roll milling at any temperature sufficient to remove residual solvents such as, for example, about 50° C. to about 200° C., and/or to improve the physical properties of a sorbent sheet.

A sorbent sheet manufactured to any desired thickness. For example, a sorbent sheet may have a thickness of less than about 10 mm, less than about 5.0 mm, less than about 2.0 mm, or less than about 1.0 mm. For example, about 0.10 mm to about 10 mm, about 0.5 mm to about 5.0 mm, about 1.0 mm to about 2.0 mm, about 0.50 mm to about 1.75 mm, about 0.25 to about 1.0 mm, about 0.25 to about 2.0 mm, about 0.50 mm to about 1.5 mm or any individual thickness or range encompassed by these example ranges, such as about 0.25 mm, about 0.5 mm, about 1 mm, about 1.5 mm, about 2.0 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm. A sorbent sheet may have a density of about 0.05 g/cm³ to about 2.0 g/cm³, such as about 0.1 g/cm³ to about 1.5 g/cm³, about 0.5 g/cm³ to about 1.3 g/cm³, or any density or range encompassed therein, such as about 0.2 g/cm³, about 0.3 g/cm³, about 0.4 g/cm³, about 0.5 g/cm³, about 0.6 g/cm³, about 0.7 g/cm³, about 0.8 g/cm³, or about 0.9 g/cm³. In any embodiment described herein, a sorbent sheet may have a density of about 0.08 g/cm³ to about 1.5 g/cm³.

One or more sorbent sheets as described above may be assembled to form a sorbent sheet product. For example, one or more sorbent sheets may be configured together in a variety of ways depending on the physical space to which conformation is desired, desired device performance, and features which are included in proximity to the sorbent sheet/s.

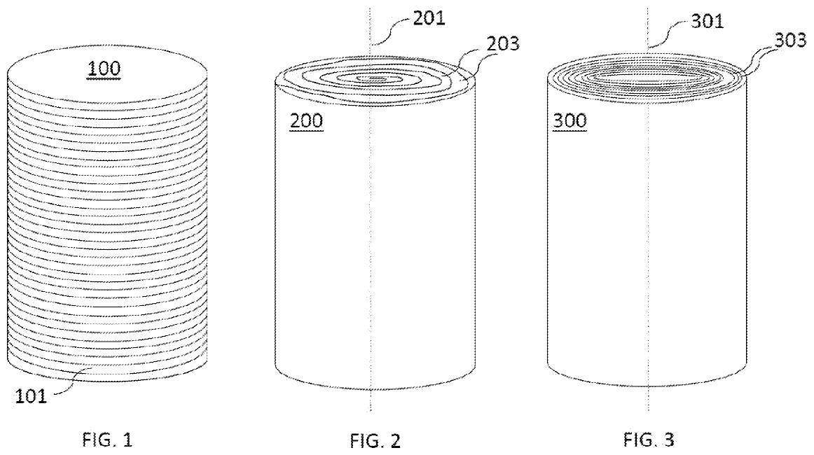

One such sorbent sheet product comprises a plurality of stacked sorbent sheets (“stacked sorbent sheet product”). One example of a stacked sorbent sheet product is depicted in FIG. 1. Stacked sorbent sheet product 100 comprises a plurality of sorbent sheets 101. As provided herein, a stacked sorbent sheet product may comprise two or more sorbent sheets, each stacked upon each other, having the properties of and comprising the sorbent material/s and binder/s in the concentrations as described in any embodiment above. A sorbent sheet manufactured according to the methods disclosed herein defines an upper surface and a lower surface. A stacked sorbent sheet product may be configured such that the at least two sorbent sheets are stacked and arranged such that adjacent upper and lower surfaces are substantially congruent with each other, thereby forming a stack of sorbent sheets. As used herein, substantially congruent refers to the overlap of at least 90% of the upper or lower surface area of one sorbent sheet with an adsorbent sheet adjacent to said upper or lower surface. Each sorbent sheet may be any desired shape or size. For example, blanks in the shape of circular disks may be punched out of a larger sorbent sheet and stacked, therefore forming a cylindrical stacked sorbent sheet product. In another example, blanks of varying shapes and sizes may be punched out of a larger sorbent sheet such that, when stacked, an irregular three-dimensional shape is formed. Optionally, each sorbent sheet in a stack of sorbent sheets may be adhered to an adjacent sorbent sheet to maintain substantial congruency. Additionally or alternatively, a stack of sorbent sheets may be contained with a housing having enclosing walls that maintain adjacent sorbent sheets in substantial congruence with each other. Optionally, a stack of sorbent sheets may be compressed to further reduce void volume and increase the density of sorbent material within the stack.

Advantageously, the stacked sorbent sheet products described herein are dense and therefore exhibit a high capacity for low-density hydrocarbon storage. A stacked sorbent sheet product may have an average density of about 80 kg/m³ to about 1500 kg/m³, about 500 kg/m³ to about 2000 kg/m³, about 750 kg/m³ to about 1500 kg/m³, about 900 kg/m³ to about 1200 kg/m³, about 900 kg/m³ to about 1050 kg/m³, about 400 kg/m³ to about 500 kg/m³, about 500 kg/m³ to about 600 kg/m³, about 500 kg/m³ to about 550 kg/m³, about 600 kg/m³ to about 650 kg/m³, about 650 kg/m³ to about 700 kg/m³, or about 700 kg/m³ to about 750 kg/m³.

Another example of a sorbent sheet product contemplated herein comprises one or more sorbent sheets concentrically arranged around a central axis thereby creating a “rolled” sorbent sheet product. A rolled sorbent sheet product may comprise one or more sorbent sheets, each sorbent sheet having the properties and comprising binder/s and sorbent material/s in the concentrations as described in any embodiment above. In one example configuration, such as shown in FIG. 2, a rolled sorbent sheet product 200 may comprise a sorbent sheet that is spiral-wound about a central axis 201 to create concentrically adjacent sheet layers 203. One or more sorbent sheets may be wound together.

While the term “rolled” is used herein to describe a sorbent sheet product of this type, this terminology is used for convenience and does not limit arrangements to those that are capable of rolling (e.g., cylindrical or elliptical) nor does “rolled” limit the methods by which such a rolled sorbent sheet product may be manufactured. A rolled sorbent sheet product as described herein may be generally cylindrical shaped, although any dimension can be employed, including conical, or frustro-conical variations, as well as ellipsoids, squares/rectangles, or other shapes.

As used herein, a rolled sorbent sheet product refers to a structure displaying any form of layering of one or more sorbent sheets, for example, by winding, spiral winding, concentric layering, or combination thereof, to form a tubular (of any cross-sectional shape, e.g., round, elliptical, square, triangular, rectangle, and the like) structure. As another example, a plurality of sorbent sheets can be stacked and then wound together to form a similar cylindrical shape. As another alternative, several sheets, each formed into a hollow cylinder, may be arranged to from concentric rings in cross-section of a similarly sized cylinder. Such a variation is shown in FIG. 3, where concentric sheets 303 are arranged about a central axis 301 to form a rolled sorbent sheet product 300 in a nested configuration. Various combinations of these and other arrangements may be used to fill space within any shape of housing or canister, as described elsewhere herein.

Advantageously, the rolled sorbent sheet products described herein are dense and therefore exhibit a higher capacity for low-density hydrocarbon storage. The density of a rolled sorbent sheet product may be calculated based on the formulas below:

$$Roll Density Calculations ( US units )$$

$$\begin{matrix}BW : Basis Weight ( \frac{oz}{{yd}^{2}} ) & L : Length on Roll ( yd ) \\ OD : Outer Roll Diameter ( in ) & ID : \frac{Inner Roll Diameter}{Core Diameter ( in )} \\ W : Machine width or roll length ( in ) & ρ : Roll Density ( \frac{lb}{{ft}^{2}} )\end{matrix}$$

$$ρ ( \frac{lb}{{ft}^{2}} ) = ( 3 ) * \frac{BW * L}{( \frac{{OD}^{2}}{4} - \frac{{ID}^{2}}{4} ) * π}$$

$$Roll Density Calculations ( SI units )$$

$$\begin{matrix}BW : Basis Weight ( \frac{g}{{m}^{2}} ) & L : Length on Roll ( m ) \\ OD : Outer Roll Diameter ( mm ) & ID : \frac{Inner Roll Diameter}{Core Diameter ( mm )} \\ W : Machine width or roll length ( mm ) & ρ : Roll Density ( \frac{kg}{{m}^{2}} )\end{matrix}$$

$$ρ ( \frac{kg}{{m}^{2}} ) = ( 1000 ) * \frac{BW * L}{( \frac{{OD}^{2}}{4} - \frac{{ID}^{2}}{4} ) * π}$$

A rolled sorbent sheet product may be manufactured to have an average roll density of about 80 kg/m³ to about 1500 kg/m³, about 500 kg/m³ to about 2000 kg/m³, about 750 kg/m³ to about 1500 kg/m³, about 900 kg/m³ to about 1200 kg/m³, about 900 kg/m³ to about 1050 kg/m³, about 400 kg/m³ to about 500 kg/m³, about 500 kg/m³ to about 600 kg/m³, about 500 kg/m³ to about 550 kg/m³, about 600 kg/m³ to about 650 kg/m³, about 650 kg/m³ to about 700 kg/m³, or about 700 kg/m³ to about 750 kg/m³.

As such, in any embodiment, a stack of sorbent sheets and/or rolled sorbent sheets may be assembled within a housing to provide a low-density hydrocarbon storage device having a decreased void volume and therefore a higher capacity for low-density hydrocarbon storage. In particular, provided herein is an adsorptive low-density hydrocarbon storage device comprising a housing, which partially or totally encapsulates one or more of a stacked or rolled sorbent sheet product as described above. Suitable housing may be configured in a variety of shapes, for example tetrahedrons, cubes and cuboidal shapes, cylinders, spheres, hyperboloids of a single sheet, conical shapes, ellipsoidal shapes, rectangular shapes, hyperbolic paraboloid shapes, elongate bar shapes, paraboloids, and combinations of these shapes (e.g., irregular shaped). Advantageously, the enhanced storage capacity of the rolled and stacked sorbent sheet products described herein do not require high pressures (e.g., greater than about 900 psi (6.2 MPa)) to achieve that enhanced storage capacity, thereby allowing for the use of irregular-shaped housings as well as lower-cost materials such as those rated for lower pressure applications. Combinations of shapes may be selected to define different sections of a storage device. There is no particular restriction on a material from which the tank housing may be constructed. Exemplary materials include, but are not limited to, metal, composite, polymer materials and combinations thereof.

By incorporating one or more of a stacked sorbent product and a rolled sorbent sheet product, an adoptive low-density hydrocarbon storage device may achieve a void volume of about 30% or less within an enclosing housing. For example, an adsorptive low-density hydrocarbon storage device may exhibit a void volume of about 28% or less, about 25% or less, or about 20% or less. As such, an adsorptive low-density hydrocarbon storage device comprising a rolled sorbent sheet product and/or a stacked sorbent sheet product as described herein may exhibit improved performance over a device containing an equivalent volume of activated carbon provided in pelletized or powdered form. For example, an adsorptive low-density hydrocarbon storage device may have a higher storage capacity for low-density hydrocarbons than other storage devices known in the art. The storage capacity may be achieved concomitantly with the ability to maintain the device at a lower partial pressure, e.g., about 100 psi (0.689 MPa) to about 700 psi (4.83 MPa). Additionally, an adsorptive low-density hydrocarbon storage device as provided herein, particularly embodiments wherein the sorbent is carbonaceous, may require a reduced equilibration time due to a higher density of carbonaceous material. In particular, faster filling times may be achieved due to more efficient dissipation of heat of adsorption. Similarly, a device may be emptied of stored gasses faster through more efficient energy transfer into the device.

An adsorptive low-density hydrocarbon storage device may optionally comprise an energy transfer mechanism that facilitates transfer of energy out of the storage device, such as is needed during gas adsorption, or into the device, such as is needed during gas desorption. There are no restrictions on construction of heat transfer mechanism. In any embodiment, a heat transfer mechanism may include at least one channel for transporting fluids including liquids and/or gases. For example, a fluid may be a phase change material such as water, alcohol, or a mixture of water and alcohol that evaporates and condenses at various times during normal operation of the low-density hydrocarbon storage device within which it is incorporated. A channel may be formed within one or more sorbent sheets themselves, or may be provided as one or more heat pipes formed from a thermally conductive material, such as copper or aluminum, and which enclose a fluid. Alternatively, a channel may be a pipe and the fluid may be a liquid coolant or gas coolant that circulates through a low-density hydrocarbon storage device.

A channel, as described above, may be optionally connected to one or more sorbent sheets by way of a thermal interface material to improve thermal conductivity. Suitable thermal interface materials are not limited and may include one or more of thermal paste, thermal adhesive, thermal conductive pads, thermal tape, and metal thermal interface materials. Alternatively, a thermal interface material is omitted and a channel contacts one or more sorbent sheets themselves.

To provide energy (as heat) or remove energy (as heat) from a low-density hydrocarbon storage device, a heat source, a heat sink, or both a heat source and heat sink are provided. Examples of suitable heat sources include electric heaters, thermoelectric heaters, heat pumps, combustion heaters that use liquid fuels or gas fuels, air exchange heater, heaters that obtain heat from vehicle exhaust gases, heaters that obtain heat from vehicle coolant, or heaters that obtain heat from vehicle engine oil. Examples of heat sinks include one or more of a housing, thermoelectric (Peltier) coolers, heat pumps, air exchange heatsinks, water exchange heat sinks, coolant reservoirs, phase transfer materials, and evaporative coolers such as water sprayers.

A low-density hydrocarbon storage device may be filled or loaded with low-density hydrocarbons, e.g., natural gas, by conventional means known in the art. Advantageously, when compared to compressed or liquid-based storage systems, adsorptive storage systems may be maintained at a lower pressure, such as about 0.689 MPa (100 psi) to about 5.52 MPa (800 psi) gauge pressure, or about 1.38 MPa (200 psi) to about 4.83 MPa (700 psi), or about 2.07 MPa (300 psi) to about 4.14 MPa (600 psi). In particular, an adsorptive low-density hydrocarbon storage device as described herein may be pressurized to about 2.07 MPa (300 psi) to about 4.83 MPa (700 psi) or about 3.45 MPa (500 psi).

Notably, when compared to similar devices filled with sorbents in powder, pelleted, or granular carbon, a low-density hydrocarbon storage device as described herein, exhibits a higher volumetric energy density, and thus higher energy storage capacity in a given volume for low-density hydrocarbons. Further, filling and/or emptying (adsorbing/desorbing) the device with low-density hydrocarbon gasses may be achieved more rapidly with lower required equilibrium times.

There is provided a stacked sorbent sheet product comprising a plurality of sorbent sheets, each sorbent sheet within the stacked sorbent sheet product comprising at least one sorbent material and at least one binder, wherein the plurality of sorbent sheets is arranged such that each sorbent sheet is substantially congruent with the sorbent sheet adjacent thereto thereby forming stacked sorbent sheets and having a void volume of about 10% or less.

In some embodiments, each sorbent sheet comprises about 85 wt. % to about 95 wt. % of the sorbent material.

In some embodiments, each sorbent sheet comprises about 90 wt. % of the sorbent material.

In some embodiments, the sorbent material comprises one or more of activated carbon, reactivated carbon, natural or synthetic zeolite, silica, nanotubes, and graphene.

In some embodiments, the binder comprises one or more of a polytetrafluoroethylene (PTFE), polyvinylidene fluoride, ethylene-propylene-diene rubber, polyethylene oxide, UV-curable acrylate, UV-curable methacry late, heat-curable divinyl ether, polybutylene terephthalate (PBT), acetal or polyoxymethylene resin, fluoroelastomer, perfluoroelastomer (FFKM) and/or tetrafluoro ethylene/propylene rubber (FEPM), aramid polymer, para-aramid polymer, meta-aramid polymer, poly trimethylene terephthalate (PTT), ethylene acrylic elastomer, polyimide, polyamide-imide, polyurethane, low-density polyethylene, high density polyethylene, polypropylene, biaxially-oriented polypropylene (BoPP), polyethylene terephthalate (PET), biaxially-oriented polyethylene terephthalate (BoPET), polychloroprene, and any copolymer of any thereof.

In some embodiments, the binder comprises PTFE.

In some embodiments, the sorbent material comprises activated carbon.

In some embodiments, each of the plurality of sheets has a thickness of about 0.10 mm to about 10 mm.

In some embodiments, the stacked sorbent sheet product has a density of about 80 kg/m³ to about 1500 kg/m³.

In some embodiments, the stacked sorbent sheets have been subjected to compression.

In some embodiments, the stacked sorbent sheets form a cylindrical shape.

There is provided a rolled sorbent sheet product comprising at least one sorbent sheet configured into a tubular profile positioned about a central axis and having a void volume of about 20% or less, wherein the sorbent sheet comprises at least one sorbent material and at least one binder.

In some embodiments, the at least one sorbent sheet is spirally wound around the central axis.

In some embodiments, the rolled sorbent sheet product comprises at least two sorbent sheets arranged to form at least two concentric rings in cross-section of a similarly sized tubular structures.

In some embodiments, each of the sorbent sheets of the rolled sorbent sheet product comprise about 85 wt. % to about 95 wt. % of sorbent material.

In some embodiments, each of the sorbent sheets of the rolled sorbent sheet product comprise about 90 wt. % of the sorbent material.

In some embodiments, the sorbent material of the rolled sorbent sheet product comprises one or more of activated carbon, reactivated carbon, natural or synthetic zeolite, nanotubes, graphene, and silica.

In some embodiments, the binder of the rolled sorbent sheet produce comprises one or more of a polytetrafluoroethylene, polyvinylidene fluorides, ethylene-propylene-diene rubber, polyethylene oxide, UV-curable acrylate, UV-curable methacrylate, heat-curable divinyl ether, polybutylene terephthalate, acetal or polyoxymethylene resin, fluoroelastomer, perfluoroelastomer, tetrafluoro ethylene/propylene rubber, aramid polymer, para-aramid polymer, meta-aramid polymer, poly trimethylene terephthalate, ethylene acrylic elastomer, polyimide, polyamide-imide, polyurethane, low-density polyethylene, high density polyethylene, polypropylene, biaxially-oriented polypropylene, polyethylene terephthalate, biaxially-oriented polyethylene terephthalate, polychloroprene, and any copolymer of any thereof.

In some embodiments, the binder of the rolled sorbent sheet product comprises polytetrafluoroethylene.

In some embodiments, the sorbent material of the rolled sorbent sheet product comprises activated carbon.

In some embodiments, each of the plurality of sheets of the rolled sorbent sheet product has a thickness of about 0.10 mm to about 10 mm.

In some embodiments, the rolled sorbent sheet product has a density of about 80 kg/m³ to about 1500 kg/m³.

In some embodiments, the rolled sorbent sheet product has been subjected to compression.

There is provided a low-density hydrocarbon storage device comprising a housing that contains at least one of the stacked sorbent sheet product of claim 1 and the rolled sorbent sheet product as recited in claim 12 partially or totally encapsulated therein.

In some embodiments, the low-density hydrocarbon storage device is characterized by a void volume of about 20% (v/v) or less.

In some embodiments, the low-density hydrocarbon storage device of claim further comprises a heat transfer mechanism.

In some embodiments, the low-density hydrocarbon storage device has a volumetric energy storage density for low-density hydrocarbons that is at least 10% greater than a storage device comprising a volume of activated carbon identical to the low-density hydrocarbon storage device.

In some embodiments, the housing of the low-density hydrocarbon storage device is cylindrical.

In some embodiments, the housing of the low-density hydrocarbon storage device is irregularly shaped.

### EXAMPLES

Sorbent sheets were prepared by activating carbonaceous material obtained from coconut from Kuraray Co. Ltd. (Tokyo, Japan) until an apparent density of 0.543 g/cm³ was achieved. The activated carbon was pulverized to an average particle size of about 7 microns and mixed with 15 wt. % powdered PTFE particles to form a premixture. The premixture was processed into a sheet using a roller mill heated to 80° C. to produce a 0.5 mm-thick sheet 0.5 meters wide. The density of the sheet was 0.88 g/cm³. Roughly 500 disks were cut from the sheet having the same diameter as the inside diameter of a Welker CP2G constant pressure cylinder. The disks were stacked in the cylinder to achieve a void density of less than 10% (0.80 g/cm³ density).

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

What is claimed is:

1. A low-density hydrocarbon storage device comprising:
a housing for storing a low-density hydrocarbon: wherein the housing contains a multi-layered sorbent sheet product having a void volume of about 20% (v/v) or less, wherein the multi-layered sorbent sheet product is partially or totally encapsulated within the housing.

2. The low-density hydrocarbon storage device of claim 1, wherein the multi-layered sorbent sheet product is at least one of:
a stacked sorbent sheet product comprising a plurality of sorbent sheets, each sorbent sheet within the stacked sorbent sheet product comprising at least one sorbent material and at least one binder, wherein the plurality of sorbent sheets is arranged such that each sorbent sheet is substantially congruent with the sorbent sheet adjacent thereto thereby forming stacked sorbent sheets and having a void volume of about 10% or less, and
a rolled sorbent sheet product comprising at least one sorbent sheet configured into a tubular profile positioned about a central axis and having a void volume of about 20% or less, wherein the sorbent sheet comprises at least one sorbent material and at least one binder.

3. The low-density hydrocarbon storage device of claim 1, further comprising a heat transfer mechanism.

4. The low-density hydrocarbon storage device of claim 1, having a volumetric energy storage density for low-density hydrocarbons that is at least 10% greater than a storage device comprising a volume of activated carbon identical to the volume of the multi-layered sorbent sheet product.

5. The low-density hydrocarbon storage device of claim 1, wherein the housing is cylindrical.

6. The low-density hydrocarbon storage device of claim 1, wherein the housing is irregularly shaped.

7. The low-density hydrocarbon storage device of claim 1, wherein each sorbent sheet comprises about 85 wt. % to about 95 wt. % of the sorbent material.

8. The low-density hydrocarbon storage device of claim 1, wherein each sorbent sheet comprises about 90 wt. % of the sorbent material.

9. The low-density hydrocarbon storage device of claim 2, wherein the sorbent material comprises one or more of activated carbon, reactivated carbon, natural or synthetic zeolite, silica, nanotubes, and graphene.

10. The low-density hydrocarbon storage device of claim 2, wherein the binder comprises one or more of a polytetrafluoroethylene (PTFE), polyvinylidene fluoride, ethylene-propylene-diene rubber, polyethylene oxide, UV-curable acrylate, UV-curable methacrylate, heat-curable divinyl ether, polybutylene terephthalate (PBT), acetal or polyoxymethylene resin, fluoroelastomer, perfluoroelastomer (FFKM) and/or tetrafluoro ethylene/propylene rubber (FEPM), aramid polymer, para-aramid polymer, meta-aramid polymer, poly trimethylene terephthalate (PTT), ethylene acrylic elastomer, polyimide, polyamide-imide, polyurethane, low-density polyethylene, high density polyethylene, polypropylene, biaxially-oriented polypropylene (BoPP), polyethylene terephthalate (PET), biaxially-oriented polyethylene terephthalate (BoPET), polychloroprene, and any copolymer of any thereof.

11. The low-density hydrocarbon storage device of claim 2, wherein the binder comprises PTFE.

12. The low-density hydrocarbon storage device of claim 2, wherein the sorbent material comprises activated carbon.

13. The low-density hydrocarbon storage device of claim 2, wherein each of the plurality of sheets has a thickness of about 0.10 mm to about 10 mm.

14. The low-density hydrocarbon storage device of claim 2, wherein the stacked sorbent sheet product has a density of about 80 kg/m³ to about 1500 kg/m³.

15. The low-density hydrocarbon storage device of claim 2, wherein the stacked sorbent sheets have been subjected to compression.

16. The low-density hydrocarbon storage device of claim 2, wherein the stacked sorbent sheets form a cylindrical shape.

17. The low-density hydrocarbon storage device of claim 2, wherein the multi-layered sorbent sheet product comprises at least one sorbent sheet configured into a tubular profile positioned about a central axis and having a void volume of about 20% or less, wherein the sorbent sheet comprises at least one sorbent material and at least one binder.

18. The low-density hydrocarbon storage device of claim 17, wherein the at least one sorbent sheet is spirally wound around the central axis.

19. The low-density hydrocarbon storage device of claim 17, comprising at least two sorbent sheets arranged to form at least two concentric rings in cross-section of a similarly-sized tubular structures.

20. The low-density hydrocarbon storage device of claim 17, wherein the rolled sorbent sheet product has a density of about 80 kg/m³ to about 1500 kg/m³.

21. The low-density hydrocarbon storage device of claim 17, wherein the rolled sorbent sheet product has been subjected to compression.

22. A method for selectively storing or delivering low-density hydrocarbons, comprising steps of:
providing low-density hydrocarbon storage device which comprises a housing for storing a low-density hydrocarbon; wherein the housing contains a multi-layered sorbent sheet product having a void volume of about 20% (v/v) or less, wherein the multi-layered sorbent sheet product is partially or totally encapsulated within the housing:
selectively filling or emptying the low-density hydrocarbon storage device,
wherein filling the low-density hydrocarbon storage device comprises adsorbing one or more low-density hydrocarbons onto the multi-layered sorbent sheet product for storing the low-density hydrocarbon in the storage device, and
emptying the low-density hydrocarbon storage device comprises desorbing one or more low-density hydrocarbons from the multi-layered sorbent sheet product for delivering the low-density hydrocarbon from the storage device.

23. The method of claim 22, wherein the multi-layered sorbent sheet product is selected from one or more of a stacked sorbent sheet product comprising a plurality of sorbent sheets, each sorbent sheet within the stacked sorbent sheet product comprising at least one sorbent material and at least one binder, wherein the plurality of sorbent sheets is arranged such that each sorbent sheet is substantially congruent with the sorbent sheet adjacent thereto thereby forming stacked sorbent sheets and having a void volume of about 10% or less, and a rolled sorbent sheet product comprising at least one sorbent sheet configured into a tubular profile positioned about a central axis and having a void volume of about 20% or less.

24. The method of claim 22, wherein the low-density hydrocarbon is natural gas.
